(19) United States
(12) Patent Application Publication
(10) Pub. No.: US 2006/0001242 A1
(43) Pub. Date: Jan. 5, 2006

(54) COLLAPSIBLE CHAIR

(76) Inventor: Lori Amthor Fulks, Bourbonnais, IL (US)

Correspondence Address: RICHARD D. FUERLE, 1711 W. RIVER RD., GRAND ISLAND, NY, 14072, US

(21) Appl. No.: 10/710,349

(22) Filed: Jul. 2, 2004

(51) Int. Cl. A47C 4/28; B62B 7/00

(52) U.S. Cl. 280/647

(57) ABSTRACT

A collapsible chair has two front legs, two back legs, a flexible seat, a flexible back, an arm rest on each side of the seat, at least one wheel attached to the bottom of each back leg, netting between the seat and each arm rest, and a handle attached to the top of the back. The chair can be pulled by the handle when the chair is in an open position or in a collapsed position. Various items can be placed on the seat when the chair is being pulled. The chair can be locked in either an open position or in a closed position.

### BACKGROUND OF INVENTION

This invention relates to a collapsible chair that can be pulled by a handle in either a collapsed position or in an uncollapsed, open position. In particular, it relates to a chair that has wheels on the back legs, that collapses by having the sides move towards the center, and that has a handle for pulling the chair when it is open or collapsed.

There are many outdoor events that require people to bring their own chairs. These include concerts, picnics, and sporting events, such as soccer matches. Many people find it cumbersome to lug their own chairs to and from such events, even if they are physically capable of doing so. If parents attend with children, they may have to bring along chairs for themselves and their children, in addition to food, drinks, sports equipment, and other items. A single adult may find it impossible to carry everything in a single trip and may have to make more than one trip. This can be very inconvenient, especially when the parking area is a considerable distance away from the event.

Collapsible chairs have lessened this burden somewhat. Made of tubing with fabric seats and backs, they are lightweight and do not take up much space when collapsed. However, a person with children may still have to carry many of these chairs, in addition to all sorts of other items. Furthermore, companies are producing deluxe collapsible chairs that have more features are them; these chairs are heavier and even more difficult to carry.

### SUMMARY OF INVENTION

I have invented a collapsible chair that has wheels on it and can be pulled either when it is collapsed or when it is open. The chair is provided with a handle with which it can be pulled and the handle adjusts to either the collapsed or open position of the chair. If the chair is pulled when it is open, various items can be placed on the seat and they are prevented from falling off the seat by netting between the arms of the chair and the seat.

Children, who otherwise may not be able to carry a collapsible chair, are usually capable of pulling the chair of this invention. And, because drinks, food, and sporting equipment can be placed on the seat of the chair and the chair can be pulled in an open position, it may not be necessary to carry any items at all.

### BRIEF DESCRIPTION OF DRAWINGS

FIG. 1 is an isometric view showing of a certain presently preferred embodiment of a collapsible chair according to this invention in an open position.

FIG. 2 is an isometric view of the chair shown in FIG. 1 in a collapsed position.

FIG. 3 is a rear view of the collapsible chair of FIG. 1 in an open position, but with a double lock on the rear legs.

FIG. 4 is a rear view of the collapsible chair shown in FIG. 3 in a collapsed position.

### DETAILED DESCRIPTION

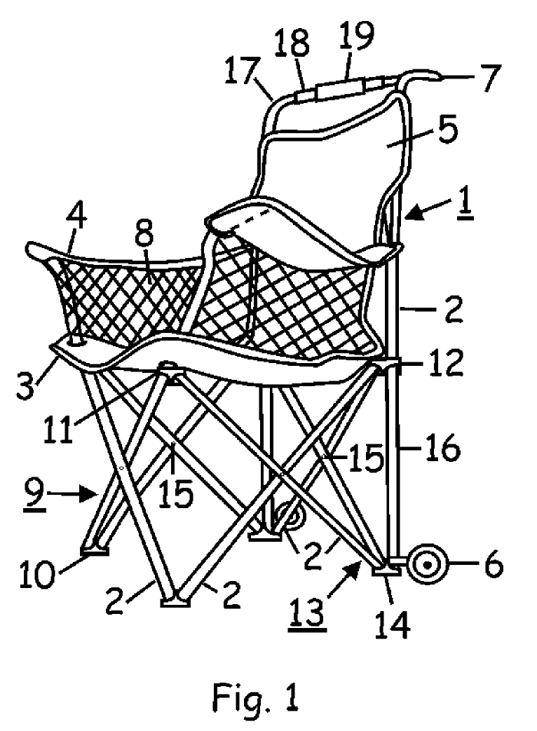

In FIGS. 1 to 4, collapsible chair 1 is made of rigid elongated members 2 to which is attached flexible seat 3, arm rests 4, and back 5. Chair 1 is also provided with wheels 6, a handle 7, and netting 8.

Rigid elongated members 2 are preferably tubular to reduce weight. They are preferably made of steel or aluminum but may also be made of other materials, such as plastic or fiberglass. In more detail, each front leg 9 of chair 1 is a pair of members 2 that are attached to a front foot connector 10. One member in each pair is attached to the front seat connector 11 on the opposite side of chair 1 and the other member in each pair is attached to a back seat connector 12 on the same side of chair 1. One of the members 2 that is attached to a front seat connector 11 may extend beyond that front seat connector to support arm rest 4.

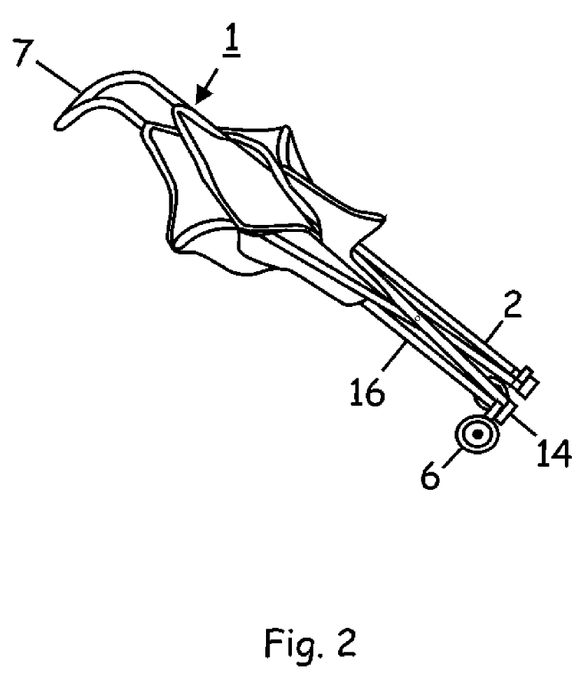

Each back leg 13 of chair 1 has a pair of members 2 that are attached to a back foot connector 14. One member in each back leg pair is attached to a front seat connector 11 on the same side of chair 1 and the other member in each pair is attached to a back seat connector 12 on the opposite side of chair 1. All pairs of leg members are rotatably attached to front and back foot and seat connectors so that they can rotate in orthogonal planes (i.e., in planes that are 90 degrees apart). Pins 15 rotatably connect front and back leg members 2 where they cross. Each back leg 13 also includes a third member 16 that is fixed to back foot connector 14, is slidably connected to back seat connector 12, extends upward to support back 5, and connects to handle 7. When chair 1 is collapsed, all of the diagonal leg members 2 move so that they are parallel, or almost parallel, as shown in FIG. 2. This invention also applies to other types of collapsible chairs, where all of the members that form the legs move to a more aligned position when the chair is collapsed. For an example of a collapsible chair, see U.S. Pat. No. 6,322,138, herein incorporated by reference.

Seat 3, arm rests 4, and back 5 are made of a flexible material, such as woven fabric or plastic sheeting. The material may be canvas, cotton, or various synthetic polymers, such as polyamide, polyester, or polycarbonate. Seat 3 may be attached to front seat connectors 11 and back seat connectors 12. Back 5 may be an extension of seat 3; i.e., seat 3 and back 5 may be a single piece. Back 5 may be attached to third members 16 by sleeves through which the third members pass, by rivets, or by other means.

Wheels 6 may be a pair of wheels or a single wheel on each back leg. They are preferably attached behind third member 16 so that they do not touch the ground and do not bear weight except when the chair is tipped for pulling, as shown in FIG. 2.

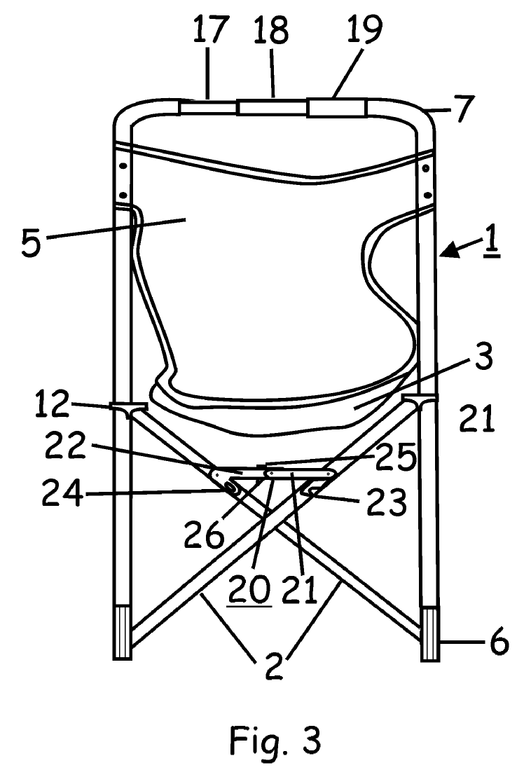

Handle 7 is attached between third members 16. Handle 7 is preferably perpendicular to third members 16, both when the chair is open and when it is collapsed so that the chair can be pulled by handle 7 in either condition. Handle 7 may be made of a flexible material, but it is preferably rigid and tubular. If handle 7 is rigid, then when chair 1 is collapsed, handle 7 collapses as well. This may be accomplished, for example, if handle 7 telescopes, as shown in FIGS. 1 and 3 where handle 7 is made of three tubes 17, 18, and 19. Tube 17 has an outside diameter less than the inside diameter of 18 and tube 18 has an outside diameter less than the inside diameter of tube 19, so that tube 18 slides inside tube 19 and tube 17 slides inside tube 18. Handle 7 may also be made of two rigid pieces hinged together at one end and rotatably attached to third members 16 at the other end. While handle 7 is preferably permanently attached to both third members 16, handle 7 may also be a single piece that is rotatably attached to one third member 16 and is releaseably attached to the other third member 16. A soft cover may enclose handle 7, if desired.

Preferably, handle 7 is also extendable towards and away from chair 1, so that it can be positioned closer to chair 1 to enable children can pull it more easily and then extended to a position farther from chair 1 for adults. This may also be accomplished by sliding one tube inside of another, using a lock to hold the handle in different positions, such as a button attached to the inside tube that a spring pushes into an aperture in the outside tube.

Netting 8 prevents items placed on seat 3 from falling off when chair 1 is being pulled by handle 7. Netting 8 is attached to seat 3 and to arms rests 4 and is preferably also attached to back 5 so that items cannot fall between netting 7 and back 5. Netting 7 may have spacings of about ⅛ to about 1½ inches, but the spacings are preferably about ¼ to about ¾ inches.

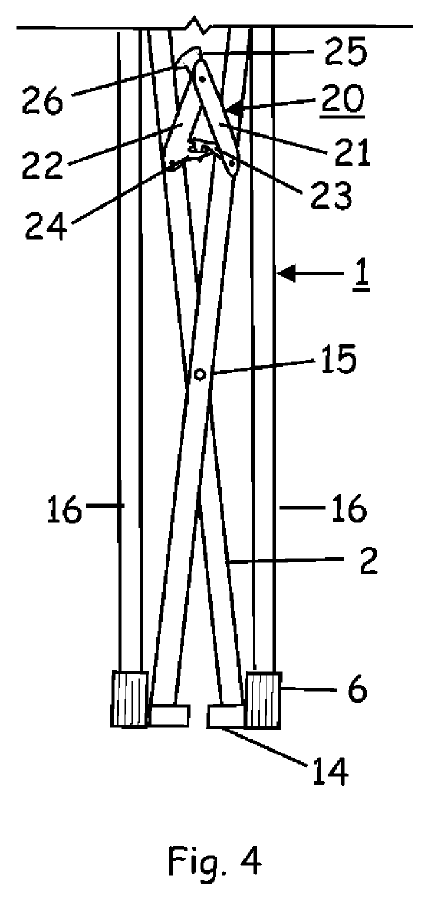

Referring to FIGS. 3 and 4, chair 1 is also preferably provided with a two-way lock 20, which can prevent chair 1 from opening if it is collapsed and can also prevent chair 1 from collapsing when it is being used to transport items. Lock 20 is formed from two arms 21 and 22, rotatably joined together and rotatably attached to two back leg members 2 that extend between back foot connectors 14 and back seat connectors 12. A hook 23 is rotatably attached to member 2 where arm 21 is attached. Hook 23 may be inserted into aperture 24 in arm 1 to lock the chair in a collapsed position, as shown in FIG. 4. A second hook 25 is rotatably attached at the juncture of arms 21 and 22. Hook 25 has a nub 26 at one end, which snaps under arm 22 to lock the chair in an open position, as shown in FIG. 3. Other means of locking the chair may also be used.

1. A collapsible chair having
(A) two front legs;
(B) two back legs;
(C) a flexible seat;
(D) a flexible back;
(E) an arm rest on each side of said seat;
(F) at least one wheel attached to the bottom of each back leg;
(H) netting between said seat and each arm rest; and
(G) a handle attached to the top of said chair,
whereby said chair can be pulled by said handle when said chair is in an open position.

2. A collapsible chair according to claim 1 wherein a single wheel is attached to the bottom of each back leg.

3. A collapsible chair according to claim 1 wherein dual wheels are attached to the bottom of each back leg.

4. A collapsible chair according to claim 1 wherein said wheels bear weight only when said chair is tipped and is pulled by said handle.

5. A collapsible chair according to claim 1 including a lock for releasably holding said chair in a collapsed or open position.

6. A collapsible chair according to claim 1 wherein said handle is attached to both sides of said chair.

7. A collapsible chair according to claim 6 wherein said handle is hollow and comprises at least two sections, each of a different diameter, where smaller sections slide into larger sections when said chair is collapsed.

8. A collapsible chair according to claim 1 wherein said handle is extendable towards and away from said seat.

9. A collapsible chair according to claim 1 wherein said flexible seat and flexible back are made of fabric.

10. A collapsible chair according to claim 1 wherein said legs are tubular and are made of steel or aluminum.

11. A collapsible chair according to claim 1 wherein
(A) each front leg comprise a pair of members attached to a front foot connector, where one member in each pair is also attached to a front seat connector on the opposite side of said chair and the other member in each pair is also attached to a back seat connector on the same side of said chair; and
(B) each back leg comprises
(1) a pair of members attached to a back foot connectors, where one member in each pair is also attached to a back seat connector on the opposite side of said chair and the other member in each pair is also attached to a front seat connector on the same side of said chair; and
(2) two third members, each fixed to a back foot connector and slidably connected to a back seat connector on the same side of said chair, and each extending beyond said back seat connector to support said back and said handle, where said pairs of members are attached to said front and back foot connectors and to said front and back seat connectors so that they can rotate in planes 90 degrees apart, and where pins rotatably join said members where they cross.

12. A collapsible chair according to claim 11 wherein said lock comprises
(A) a first arm rotatably attached to a first member that is attached to a back foot connector and to a back seat connector;
(B) a second arm rotatably attached to said first arm and to the other member that is attached to a back foot connector and to a back seat connector, where said second arm is provided with an aperture;
(C) a first hook rotatably attached to first member, where said first hook can be inserted into said aperture to lock said chair in a collapsed position; and
(D) a second hook rotatably attached to said first and second arms where they attach to each other, where said second hook has a nub that can snap under said second arm to lock said chair in an open position.

13. A collapsible chair according to claim 11 where said members that are attached to said front foot connectors and to said front seat connectors extend beyond said front seat connectors and support said arm rests.

14. A collapsible chair according to claim 1 wherein the openings in said netting are about ¼ to about ¾ inches.

15. A collapsible chair according to claim 1 wherein said netting is also attached to said back.

16. A method of transporting items comprising placing said items on the seat of a collapsible chair according to claim 1 and pulling said chair by said handle.

17. A collapsible chair having
(A) two front legs;
(B) two back legs;
(C) a flexible seat;
(D) a flexible back;
(E) an arm rest on each side of said seat;
(F) at least one wheel attached to the bottom of each back leg;
(G) a lock for securing said chair in an open position or in a collapsed position;
(H) netting between said seat and each arm rest; and
(I) a collapsible handle attached to the top of each side of said chair, whereby said chair can be pulled by said handle when said chair is in an open position or in a collapsed position.

18. A method of transporting items comprising placing said items on the seat of a collapsible chair according to claim 17 and pulling said chair by said handle.

19. A collapsible chair having
(A) two front legs, where each front leg comprise a pair of members attached to a front foot connector, where one member in each pair is also attached to a front seat connector on the opposite side of said chair and the other member in each pair is also attached to a back seat connector on the same side of said chair;
(B) two back legs, where each back leg comprises
(1) a pair of members attached to a back foot connectors, where one member in each pair is also attached to a back seat connector on the opposite side of said chair and the other member in each pair is also attached to a front seat connector on the same side of said chair; and
(2) two third members, each fixed to a back foot connector and slidably connected to a back seat connector on the same side of said chair, and each extending beyond said back seat connector to support said back and said handle, where said pairs of members are attached to said front and back foot connectors and to said front and back seat connectors so that they can rotate in planes 90 degrees apart, and where pins rotatably join said members where they cross;
(C) a flexible seat;
(D) a flexible back;
(E) an arm rest on each side of said seat;
(F) two wheels attached to the bottom of each back leg;
(G) a lock for securing said chair in an open position or in a collapsed position;
(H) netting on each side of said chair attached to said seat, an arm rest, and said back; and
(I) a collapsible, telescoping handle attached to the top of each side of said chair, whereby said chair can be pulled by said handle when said chair is in an open position or in a collapsed position.

20. A method of transporting items comprising placing said items on the seat of a collapsible chair according to claim 19 and pulling said chair by said handle.
